(19) United States
(12) Patent Application Publication
(10) Pub. No.: US 2014/0346985 A1
(43) Pub. Date: Nov. 27, 2014

(54) DRIVE INVERTER HAVING A TORQUE ERROR DETECTOR

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Pierre Alain Magne, Clermont-Ferrand (FR); Jean-Louis Linda, Clermont-Ferrand (FR)

(21) Appl. No.: 14/366,373

(22) PCT Filed: Dec. 19, 2012
(86) PCT No.: PCT/EP12/76220

§ 371 Date: Jun. 18, 2014

(30) Foreign Application Priority Data
Dec. 21, 2011 (FR) 1162162

(51) Int. Cl. H02P 6/00; H02P 6/24; G01L 3/10

(52) U.S. Cl. CPC H02P 6/002; G01L 3/10; H02P 6/24
USPC 318/400.15

(57) ABSTRACT

An inverter, which drives an electric motor installed in a road vehicle, includes sensors, a storage apparatus, a power calculator, a torque calculator, a deviation calculator, and a torque corrector. The sensors measure at least one voltage and at least one current within the inverter. The storage apparatus records values measured during an electric revolution of the motor. Following the electric revolution, the power calculator calculates a mean electric power based on the recorded values. From the mean electric power and a rotational speed of the motor during the electric revolution, the torque calculator calculates a torque produced on an output shaft of the motor, The deviation calculator determines a deviation between the torque produced on the output shaft and a setpoint torque of the inverter. When an absolute value of the deviation is greater than a predetermined threshold, the torque corrector makes a torque correction.

### FIELD OF THE INVENTION

The present invention relates to electric motors and control thereof. The present invention more specifically relates to inverters for driving such motors.

The present invention is found in particular in the field of motor vehicles utilizing electric motors, used in particular to carry out the traction function. The present invention in particular relates to road vehicles having motorized wheels or road vehicles having a central motor.

### PRIOR ART

It is known that a synchronous electric motor, such as those used in motor vehicles, comprises, on the stator, a magnetic circuit and wire windings for conducting electricity and capable of generating a stator magnetic flux, and, on the rotor, permanent magnets or electromagnets and a magnetic circuit generating a rotor magnetic flux; such a motor is equipped with a resolver giving the position of the rotor relative to the stator. Such a motor is always associated with an inverter in order to ensure the driving of said motor. A person skilled in the art knows that in practice such a motor is reversible, that is to say that it also functions as an alternator. Where reference is made hereinafter to a motor, this is done for ease of reference, and it is understood that there is no need in the context of the present invention to distinguish between operation as a motor and operation as an alternator.

In a very large number of applications, in particular in motor vehicles, the electrical energy source is a direct current source, such as a battery or a fuel cell, the energy being transported by a DC power bus. In this case, the inverter for driving the motor comprises an inverter transforming the DC signal into an AC signal of amplitude and of frequency adapted to the operating setpoints of the motor. The role of the three-phase inverter associated with a permanent magnet synchronous motor is to generate a desired mechanical torque at the motor output shaft from a DC power feed.

In the majority of applications requiring significant powers, three-phase machines are used. The operating principle is as follows: the interaction between the stator magnetic field of the motor, created by the current in the winding, and the rotor magnetic field, created by the magnets, produces a mechanical torque. The inverter, from the DC supply voltage and thanks to three branches of power transistors, produces a system of three-phase currents of suitable amplitude, of suitable frequency and of suitable phase with respect to the rotor field in order to feed the three phases of the motor. In order to control the amplitude of the currents, the inverter has current sensors which make it possible to know the currents of each phase of the motor. In order to control the frequency and the phase of the currents, the inverter receives the signals of a resolver, which measures the position of the rotor relative to the stator.

On the basis of the torque-current modelling of the motor, the inverter determines the setpoints of the phase currents of the motor and implements these thanks to its regulators. The inverter therefore does not control the torque, but the current of the motor, which may prevent the detection of certain malfunctions. In the case for example of faulty components in the inverter or in the motor, it may therefore be that the currents are viewed by the inverter as being correctly controlled without producing the expected torque on the motor shaft.

In the case of an electric motor performing a traction function, it is important that the inverter-motor system respects the intention of the driver without uncontrolled response, in particular in the case of malfunction, which for example could lead to the generation of an untimely acceleration or braking torque. In the specific case of a motor vehicle having motorized wheels, comprising at least two wheels each equipped with an electric motor, it is particularly important to secure the operation of the motors in order to avoid bad behaviour of a wheel, which could lead to an undesired differential torque between wheels and to a loss of control of the vehicle by the driver.

### BRIEF DESCRIPTION OF THE INVENTION

An object of the present invention is therefore to propose a drive inverter which makes is possible to detect any motor or inverter malfunctions. A further object of the present invention is to propose a drive inverter making it possible to correct these potential malfunctions.

Thus, the present invention concerns an inverter for driving an electric motor installed in a road vehicle, said inverter comprising:
at least one sensor for measuring at least one voltage and at least one current within the inverter,
storage means for recording the values measured during an electric revolution of the motor,
means for calculating, following the electric revolution, a mean electric power on the basis of the recorded values,
means for calculating, from the mean electric power and the rotational speed of the motor during the electric revolution, a torque produced on the output shaft of the electric motor,
means for determining a deviation between the produced torque and a setpoint torque of the inverter, and
means for correcting the torque error in the case in which the deviation is greater than a predetermined threshold.
The absolute value of the determined deviation is advantageously used in order to carry out the comparison with the threshold.

In a preferred embodiment of the invention the predetermined threshold is approximately 5 Nm for example. This value may differ however from one vehicle to the other and is fixed for example on the basis of the behaviour of each vehicle in an abnormal situation.

In a specific embodiment all of the storage and calculation operations are performed not during an electric revolution, but during a revolution of the resolver. In order to obtain an absolute electric position from a measurement performed during a revolution of the resolver, it is necessary for the revolution of the resolver to be an integer multiple of the electric revolution. In an electric machine having three, or four, pairs of poles, a resolver having one pair of poles can thus be used. The acquisition of data during a resolver revolution therefore corresponds to an acquisition during three, or respectively four, electric revolutions. Such an embodiment has a number of advantages. On the one hand a greater convenience of implementation, and on the other hand a greater precision are achieved, since the calculated mean values are therefore calculated from a greater number of values, which makes it possible to increase the accuracy of the calculations.

The storage means for example comprise a first memory for recording the measurements performed during a first electric revolution or during a first resolver revolution, and a second memory for recording the measurements performed during a second electric revolution or a second resolver revolution once the calculation of the mean power has been triggered following the first electric revolution or first resolver revolution.

As described above, a drive inverter according to the invention transforms direct current to three-phase current. It is therefore possible to acquire the measurements and to estimate the torque both at the DC bus and at the three-phase current.

In a specific embodiment the inverter thus comprises at least one bus voltage sensor U_{dc} and at least one bus current sensor I_{dc}. The acquisition and storage of measurements provided by these sensors thus make it possible to determine a mean electric power across the direct current, the torque produced being determined from this power.

In a further specific embodiment, separate from the preceding embodiment, the inverter comprises sensors making it possible to measure at least two phase currents at the output of the inverter and a voltage across the DC bus. The electric power at the three-phase output of the inverter is calculated from the phase current measurements ia and ic (see FIG. 1 described further below), from the bus voltage (Udc) and from the respective commands of the pulse-width modulators (PWM-A, PWM-B, PWM-C). In this embodiment the torque produced is thus determined from the three-phase electric power.

In a specific embodiment the drive inverter further comprises means for subtracting measured losses from the mean electric power. The same losses are not subtracted depending on the electric power used. In fact, the DC power is measured at the input of the inverter, and all of the inverter losses, motor losses and losses in the three-phase line must be subtracted from said DC power. By contrast, the three-phase power is measured at the output of the inverter, and merely the motor losses and the losses in the three-phase line must therefore be subtracted from this power. These losses comprise, in particular, iron losses, variator losses and Joule losses in the motor and in the three-phase line.

In another specific embodiment the inverter comprises means for sampling, on the basis of the rotational speed of the motor, the measured values before said values are recorded. In fact, as described further below, it is useful to be able to sample the values in order to limit the number of acquired values and therefore the size of the storage means of the inverter.

In a further embodiment the inverter comprises means for calculating a setpoint torque from setpoint currents and from the rotor temperature of the motor.

In addition, in an embodiment, the inverter comprises means for transmitting the deviation between the produced torque and the measured torque to an electronic supervision device installed in the road vehicle. In a further embodiment the inverter comprises means for transmitting the state of a detected fault, determined on the basis of this deviation. In fact, in particular in the case of a vehicle having motorized wheels, if an electronic device oversees the general behaviour of the vehicle, it is useful if it has information concerning the detected malfunctions, in particular a torque error, in order to possibly order corrective action at another wheel.

In a specific embodiment the torque error correction means comprise means for stopping the electric motor. In fact, if a torque error is detected, this means that the effectively produced torque is different from the setpoint torque. In the case of a vehicle having motorized wheels, the setpoint torques of the different motors are equal or at least linked to one another. If one of the torques produced does not correspond to the setpoint torque, this may therefore lead to a destabilization of the vehicle with, for example, very different torques applied to the two front wheels of a vehicle, which may lead to a very dangerous situation. In this case, a relatively secured fallback situation consists in completely cancelling the torque on the motor within which the malfunction has been detected, this cancellation being implemented for example by completely stopping the electric motor. This stop is ordered for example by blocking the application of PWM-A, PWM-B, PWM-C orders to the power component. It should be noted here that the electric motor, in the case of a vehicle having motorized wheels, acts only on a single wheel.

In a further specific embodiment the torque error correction means comprise means for stopping the electric vehicle. The means for stopping the vehicle are, for example, controlled by an electronic supervision device of the vehicle, and the drive inverter has means for communicating with this electronic supervision device.

The present invention therefore also relates to an electronic supervision device designed to be installed in a vehicle comprising at least one first and one second sub-system for driving wheels, each sub-system comprising at least one inverter according to the invention, a wheel and an electric motor installed on said wheel.

This electronic supervision device comprises:
means for receiving a measurement performed by a sensor installed in the first sub-system,
means for determining, on the basis of the received measurement, an anomaly in the vehicle,
means for determining, on the basis of the anomaly and on the basis of a set of predetermined strategies, corrective action to be implemented in the vehicle, and
means for transmitting to the inverter installed in the second sub-system a setpoint corresponding to the corrective action.

In a specific embodiment the supervision device further comprises means for accessing a database comprising all predetermined strategies.

In a specific embodiment the predetermined strategies are comprised within the group comprising: strategies for supervising a data bus, strategies for supervising the traction of a vehicle, strategies for supervising the suspension of a vehicle, strategies for supervising the state of a DC power source installed in the vehicle, strategies for supervising the temperature within a motor and the cooling system, and strategies for supervising sensors of the vehicle.

### BRIEF DESCRIPTION OF THE FIGURES

Further objectives and advantages of the invention will become clear from the following description of a preferred but non-limiting embodiment, illustrated by the following figures, in which:

FIG. 1 shows the block diagram of a drive inverter branched over a three-phase electric motor,

FIG. 2, in the form of a block diagram, shows the calculation of a setpoint torque,

FIG. 3, in the form of a block diagram, shows the calculation of the torque effectively produced on the motor output shaft.

### DESCRIPTION OF THE PREFERRED EMBODIMENT OF THE INVENTION

FIG. 1 shows a drive inverter 10 branched over an electric three-phase motor 6. This inverter 10 comprises different elements described hereinafter. A setpoint generator 1 makes it possible to determine, on the basis of a torque C_{requested} and the limitations of the system (bus voltage and tension U_{dc} and I_{dc}, rotational speed of the motor Ω and the angular position of the rotor relative to the stator Θ), setpoints I_{d} and I_{q} to be implemented. On the basis of these setpoints Id and Iq, it is possible to determine, via a torque estimator 4, a torque C to be produced. A power to be produced can be calculated on the basis of this torque to be produced and on the basis of the rotational speed of the motor Ω.

In addition, the inverter 10 comprises a device 2 making it possible to control the setpoint currents I_{d} and Iq on the basis of the elements provided by the resolver 7 and on the basis of the applied processing 5. In fact, the resolver 7 transforms an angle, corresponding to the angular position of the rotor relative to the stator, into an electric setpoint in the form of two components (a sine and cosine component), and the processing 5 makes it possible to perform the reverse operation in order to find the value of the rotor angle and the rotational speed of the motor. On the basis of these elements, the device 2 can generate three signals PWM-A, PWM-B and PWM-C, which will be converted by the power circuit 3 into three-phase signals intended to supply the motor 6.

In such a device it is useful to secure some of the performed calculations in order to guarantee reliable operation. It is therefore useful to detect errors over the produced torque or abnormal ripples over the torque.

Because of the construction of the motor, it is normal to observe a slight torque fluctuation, of approximately a few percent, during an electric revolution. Because of the balance of the powers, the fluctuation of the output mechanical power, due to the torque fluctuation, also translates into a fluctuation of the electric power at the input of the system. The torque produced on the output shaft of the electric motor is therefore calculated from the mean mechanical power during at least one electric revolution. To this end, the inverter comprises a calculation means 30 (see FIG. 3) and sensors which measure a bus voltage U_{dc} and a bus current I_{dc}, making it possible to determine the input electric power. It should be noted here that the detailed description is implemented in the case in which the electric power is determined at the direct current, that is to say at the input of the converter. Analogue means could be detailed however in the case in which the electric power is determined at the three-phase current.

This determination of the input electric power is performed in two steps. In a first step a first table, recorded in a memory of the inverter, is filled with bus voltage and bus current measurements sampled during at least one electric revolution. It should be noted here that, in an electric machine, a mechanical revolution does not necessarily correspond to an electric revolution, since the electric revolution is dependent on the number of pairs of poles. In a machine comprising two pairs of poles, one mechanical revolution thus corresponds to two electric revolutions. In an embodiment of the present invention measurements are acquired during a resolver revolution in order to obtain information that is sufficiently complete and from which a potential torque error or a potential ripple can be deduced. During an electric revolution, the inverter therefore records the measured values in a table at a rate of one measurement every 100 microseconds.

In the following description, the term “electric revolution” will be used, however a person skilled in the art will understand that the examples detailed here also apply in the case in which a resolver revolution is used.

In the case in which the electric machine turns at a low speed however, a sampling every 100 microseconds could lead to an excessively large table. For example, for a speed of 500 rpm, such a sampling could lead to the recording of 1200 values. In a preferred embodiment a table of fixed size, for example 200 values, is thus used and the values are sub-sampled according to the rotational speed of the motor. For example, for a speed between 500 and 1500 rpm, the inverter only acquires one value in six with respect to the base sampling, that is to say one value every 600 microseconds. For a speed between 1500 and 3500 rpm, the inverter acquires only one value in three, that is to say one value every 300 microseconds. By contrast, for rotational speeds greater than 3500 rpm, it is possible to acquire values every 100 microseconds.

The second step begins when an electric revolution has elapsed. At this moment, the processing of the data recorded in the first table begins. This processing will be described in the following paragraph. At the same time, the acquisition of the values is continued during the following revolution according to the same rules, and the values are recorded in a second table. In an embodiment only two tables are used, which means that the values acquired during a third electric revolution will be recorded in the first table, instead of and in place of the values which will have been processed in the meantime.

On the basis of this data recorded in the first table, it is possible to calculate a mean power 30 by using the formula power=bus current*bus voltage and by integrating the results over the period of acquisition. This power is a mean input electric power. In order to be able to calculate the mechanical torque at the output on the motor shaft, it is necessary to obtain the mechanical power effectively consumed. In an embodiment, corresponding to a simplified approach, the mechanical torque is calculated on the basis of the mean electric power and on the basis of the rotational speed of the motor Ω. This rotational speed is in turn determined on the basis of the measurements and processing performed on the signals provided by the resolver (block 5).

In a further embodiment the inverter comprises means for applying an arbitrary yield to the electric power in order to evaluate the mechanical power which will serve for the calculation of the mechanical torque.

In yet a further embodiment the inverter comprises means for subtracting the sum 31 of motor losses from the mean electric power calculated. This approach certainly requires greater calculation time, but makes it possible to obtain greater precision.

The motor losses comprise:
Motor iron losses 32. The iron losses are dependent on the one hand on the electric frequency, therefore the rotational speed □, and on the other hand on the motor current. In order to simplify the calculations, the iron losses in the present embodiment are evaluated on the basis of motor iron losses for a mean charge current which minimizes the error of iron losses, and on the basis of the rotational speed of the motor Ω,
The variator and cable losses 33, which are dependent on the motor current Iₘₒₜ,
The motor Joule losses 34, which are calculated from Joule losses 35 according to the motor current for a winding at 180° C., transposed for the measured or evaluated operating temperature of the winding T.

If the mean mechanical power during a revolution is known, this must be divided (block 36 in FIG. 3) by the motor speed in order to determine the torque effectively produced (or torque measured) on the output shaft of the motor.

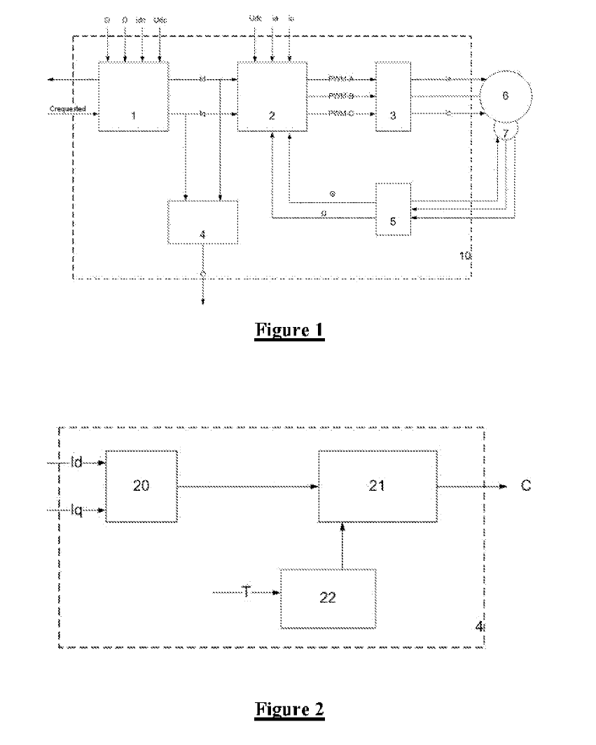

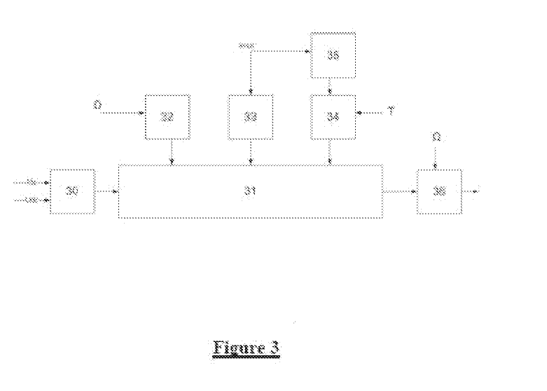

In addition, the inverter comprises means for determining the torque to be produced, as described with the aid of FIG. 2. In a first step, the motor torque at a rotor temperature of approximately 50° C. is calculated (block 20) from the setpoint currents I_{d} and I_{q}. If the rotor temperature increases, the electromagnetic torque decreases due to the negative temperature coefficient over the residual induction of the magnets. This phenomenon is particularly significant in the case of permanent magnets of the neodymium-iron-boron (NdFeB) type, which have a strong temperature coefficient.

In order to take into account this decrease, the torque at rotor temperature of approximately 50° C. is compensated for (block 21) on the basis of the actual rotor temperature. To this end, this rotor temperature is estimated (block 22).

In an example, the setpoint torque which will be used to signal a fault is the torque to be produced thus calculated. In a further example the setpoint torque is the mean between the torque to be produced calculated as indicated and the torque to be produced at the current moment in time minus one.

It is thus possible to calculate a deviation between the setpoint torque and the torque effectively produced or the measured torque. If this deviation is too great, in particular greater than a predetermined value, this indicates the presence of a malfunction in the drive inverter or in the motor, and therefore a loss of control over the motor torque.

An inconsistent motor torque leads to an untimely acceleration or braking, independently of the driver's will, which could be very dangerous in terms of the behaviour of the vehicle, and must therefore be avoided at all costs. Consequently, if the inverter detects a deviation indicating a malfunction, it orders an action to correct the error. This correction action for example is an action of stopping the electric machine, thus causing the wheel in question to freewheel.

In a specific embodiment a complementary correction action may consist of a signalling of the fault transmitted to a general supervision element of the vehicle, which may thus order an action to stop the vehicle or a correction action on another wheel of the vehicle.

In the detection process which has just been described, mean values are used, and this may therefore cause a malfunction to go undetected. In another example, an inverter according to the invention is thus also used to detect torque ripple. In fact, it is possible that the torque effectively produced on the output shaft of the motor is, on average, close to the setpoint torque, but has ripples to a greater or lesser extent. These ripples, for example, may be the sign of a malfunction of an element of the electric circuit, which could, over time, have severe consequences on the functioning of the system if corrective action is not ordered.

The detection of a torque ripple uses the same measured values as the detection of a torque error. A table is thus filled with the values measured during an electric revolution, as described above, but the processing performed on the data differs. In fact, in order to detect a torque ripple, it is necessary to calculate the mean value, over the period of acquisition, of the absolute value of the difference between the mean electric power and the instantaneous electric power, calculated from each stored torque of bus voltage and bus current values. This mean value of the absolute value of the difference is then expressed either as an absolute torque value, that is to say the difference of each power is divided by the rotational speed, or as a percentage of the mean electric power.

If this mean value is greater, as absolute value or as percentage, than a predetermined value, this means that a fault has appeared in the system, and corrective action is then ordered by the inverter. This corrective action consists, for example, in stopping the electric machine and therefore freewheeling the wheel in question.

As described above, the torque produced is determined by dividing a measured mean power by a rotational speed of the motor. If the motor operates at a very low speed, the estimated torque will tend towards a very large value. In this case, the slightest imprecision in the measurements or in the estimation of losses may lead to a misestimation of the torque produced, and thus to a misdetection of an error. Consequently, in a specific embodiment, the means for correcting the torque error are deactivated if the rotational speed is lower than a predetermined value.

In a further preferred embodiment the means for correcting the torque error are deactivated if the variation dynamic of the torque setpoint becomes too high. In fact, as described before, the measurements and calculations are performed during at least one electric revolution and can therefore only be relatively accurate if the operating point (speed, torque) is stable during the revolution in question.

The present invention does not exclude the joint use of means for detecting a torque error and means for detecting a torque ripple. Likewise, the present invention does not exclude the joint use of means for correcting these same parameters. In addition, in the case of such a joint use, the respective means may be separate or combined.

Generally, a drive inverter according to the present invention can be used in a general supervision device of a motor vehicle, implementing strategies for detecting or correcting a torque error, or can be used to detect or correct an abnormal torque ripple, it being possible for the correction actions to be applied to a wheel separate from that on which the detection was performed.

1-12. (canceled)

13. A drive inverter of an electric motor installed in a road vehicle, the inverter comprising:
sensors, which measure values that include at least one voltage and at least one current within the inverter;
a storage apparatus, which records values measured during an electric revolution of the electric motor;
a power calculator, which calculates, following the electric revolution, a mean electric power based on the measured values recorded by the storage apparatus;
a torque calculator, which calculates, from the mean electric power and a rotational speed of the electric motor during the electric revolution, a torque produced on an output shaft of the electric motor;
a deviation calculator, which determines a deviation between the torque produced on the output shaft and a setpoint torque of the inverter; and
a torque corrector, which performs a torque-error correction when an absolute value of the deviation is greater than a predetermined threshold.

14. The drive inverter according to claim 13, wherein the sensors include at least one bus voltage sensor and at least one bus current sensor.

15. The drive inverter according to claim 13, wherein the sensors include at least two phase current sensors and at least one bus voltage sensor.

16. The drive inverter according to claim 13, further comprising a subtractor, which subtracts losses measured in the electric motor from the mean electric power.

17. The drive inverter according to claim 13, further comprising a sampler, which samples, based on the rotational speed of the electric motor, the measured values before the measured values are recorded by the storage apparatus.

18. The drive inverter according to claim 13, wherein the torque corrector is able to cause the electric motor to stop.

19. The drive inverter according to claim 18, wherein the storage apparatus includes:
a first memory for recording measurements performed during a first electric revolution or during a first resolver revolution, and
a second memory for recording measurements performed during a second electric revolution or during a second resolver revolution once calculation of the mean electric power has been triggered.

20. The drive inverter according to claim 13,
wherein the road vehicle is an electric vehicle, and
wherein the torque corrector is able to cause the electric vehicle to stop.

21. The drive inverter according to claim 13, further comprising a transmitter, which transmits a deviation between the torque produced on the output shaft and a measured torque to an electronic supervision device installed in the road vehicle.

22. An electronic supervision device, designed to be installed in a vehicle that includes a first sub-system and a second sub-system for driving wheels, wherein each sub-system includes an inverter, a wheel, and an electric motor installed on the wheel, wherein each inverter includes sensors that measure values that include at least one voltage and at least one current within the inverter, a storage apparatus that records values measured during an electric revolution of the electric motor, a power calculator that calculates, following the electric revolution, a mean electric power based on the measured values recorded by the storage apparatus, a torque calculator that calculates, from the mean electric power and a rotational speed of the electric motor during the electric revolution, a torque produced on an output shaft of the electric motor, a deviation calculator that determines a deviation between the torque produced on the output shaft and a setpoint torque of the inverter, and a torque corrector that performs a torque-error correction when an absolute value of the deviation is greater than a predetermined threshold, the electronic supervision device comprising:
a receiver, which receives a measurement performed by a sensor installed in the first sub-system;
a processor, which:
determines, based on the received measurement, an anomaly in the vehicle, and
determines, based on the anomaly and a set of predetermined strategies, a corrective action to be implemented in the vehicle; and
a transmitter, which transmits to the inverter installed in the second sub-system a setpoint corresponding to the corrective action.

23. The electronic supervision device according to claim 22, wherein the processor accesses a database storing the predetermined strategies.

24. The electronic supervision device according to claim 22, wherein the predetermined strategies include any one or a combination of:
strategies for supervising a data bus,
strategies for supervising vehicle traction,
strategies for supervising vehicle suspension,
strategies for supervising a state of a DC power source installed in the vehicle,
strategies for supervising temperature within a motor and a cooling system, and
strategies for supervising the sensors of the vehicle.

25. The electronic supervision device according to claim 23, wherein the predetermined strategies include any one or a combination of:
strategies for supervising a data bus,
strategies for supervising vehicle traction,
strategies for supervising vehicle suspension,
strategies for supervising a state of a DC power source installed in the vehicle,
strategies for supervising temperature within a motor and a cooling system, and
strategies for supervising the sensors of the vehicle.
